(19) United States
(12) Patent Application Publication
(10) Pub. No.: US 2003/0095130 A1
(43) Pub. Date: May 22, 2003

(54) Texture mapping method

(76) Inventors: Teo Chin Chiang, Hsin Chu (TW); Kuo-Wei Yeh, Miaoli Hsien (TW)

Correspondence Address: MERCHANT & GOULD PC, P.O. BOX 2903, MINNEAPOLIS, MN, 55402-0903, US

(21) Appl. No.: 10/109,163

(22) Filed: Mar. 27, 2002

(30) Foreign Application Priority Data
Nov. 22, 2001 (TW) 90128923

(51) Int. Cl. G09G 5/00

(52) U.S. Cl. 345/582

(57) ABSTRACT

A texture mapping method. First, the pixels are grouped into a plurality of pixel sets. For each pixel set, a unique texture coordinate is calculated according to the texture coordinates of each pixel in the pixel set. Then, a texture filtering process is perform according to the unique texture coordinate, so as to obtain a color value of the texture filtering. Finally, the color value is assigned to each of the pixels in the pixel set.

### BACKGROUND OF THE INVENTION

1. Field of the Invention

The present invention relates to a texture mapping method, and particularly to a texture mapping method that improves the performance of a graphics system in texture filtering and reduces the number of memory accesses according to the texture's coordinates and the pixel's shape on the texture map.

2. Description of the Related Art

In a computer graphics system, a texture processing system can be illustrated as in FIG. 1. Various textures are stored in the texture storage device 10. The texture storage device 10 may be a hard drive. When a rendering engine in the computer graphics system requires one texture for texture mapping, the texture stored in the texture storage device 10 is sent to memory 12 of the graphics accelerator through a system bus 11. The rendering engine then employs texture processing unit 14 to read the texture from the memory 12 through memory bus 13, and performs a texture-mapping process.

Texture mapping is a very important technique for realism in computer generated 3D (three dimensional) images. Typically, a texture map is a two dimensional array of color values. The individual color values are called texels. Each texel has a unique address in the texture map. The address can be thought of as a column number and a row number, which are named u and v respectively. The 3D application can assign texture coordinates to any vertex of any primitive. When the computer graphics system renders a primitive, texture coordinates are calculated and the corresponding texels are accessed from memory for each pixel of the primitive. For instance, 3D applications can create objects that appear to have a wood grain pattern on them by mapping a wooden texture onto surfaces of 3D objects.

Typically, the u and v texture coordinates, which are assigned to a vertex, will be in the range of 0.0 to 1.0 inclusive. The floating-point texture coordinates represent texel centers, which often do not evaluate to integral texel addresses. For the nearest point sampling, the pixel value is set equal to the color of the texel with the closest integer address. This is a computationally low-overhead method of texture filtering. However, the effect may cause undesired graphic artifacts in the displayed image. In bilinear texture filtering, the texture-filtering module computes a weighted average of the texels values that are immediately above, below, to the left of and to the right of the nearest sample point. The bilinear texture filtering requires four memory accesses to generate one pixel's color and improves the scene's realism. Similarly, the trilinear texture filtering is more accurate than the bilinear texture filtering. However, it requires a large number of memory accesses.

FIGS. 2A, 2B and 2C illustrate the technique of nearest point sampling, bilinear texture filtering and trilinear texture filtering respectively. FIG. 2A is an example of the nearest point sampling. It illustrates a block of texels. The position PC (u,v) represents the pixel center on the texture and black dots represent texel centers. In nearest point sampling, the dashed black lines texel b is sampled to represent the pixel color. FIG. 2B illustrates the technique of bilinear texture filtering. The four adjacent texels a, b, c and d are selected to compute a weighted average of the texels values. FIG. 2C us an example of trilinear texture filtering (also called mipmap texture filtering). A mipmap is a sequence of textures, each of which is a progressively lower resolution representation of the same image. The size of each image in the mipmap is one half of the previous level in each dimension. If the level-0 mipmap (mipmap 0) has dimensions of 256×256, the dimensions of the level-1 mipmap (mipmap 1) are 128×128, the level-2 is 64×64, and so on down to 1×1. Each texel in mipmap is the combination of a 2×2 block of texels of the previous level mipmap. Referring to FIG. 2C, the texel e in mipmap 1 has a value representing an average of four texels values (a, b, c and d) in mipmap 0. In trilinear texture filtering, bilinear texture filtering is performed on the two nearest mipmaps, then interpolates linearly between the two values to determine a final pixel value in accordance with the level of detail (LOD). For example, the pixel value in FIG. 2C is equal to:

0.25×(a×w1+b×w2+c×w3+d×w4)+0.75×(e×w5+f×w6+g×w7+h×w8); where wn (w1, w2, w3, w4, w5,w6, w7 and w8) represents the weight of each texel.

From the foregoing, four or eight memory accesses are required when the bilinear filtering or trilinear filtering is performed respectively. A texture cache is usually exploited to reduce the memory bandwidth requirement for texture filtering in 3D graphics hardware design. For bilinear or trilinear texture filtering, the cache must have four or eight output ports to provide texels for one pixel in one clock cycle. Unfortunately, the area of the cache increases with the number of the I/O ports and becomes unacceptable. If desired texels cannot be obtained in one clock cycle, the 3D graphics hardware can use multipass texture filtering to achieve the same effects. However, the performance of graphics system will be sacrificed.

### SUMMARY OF THE INVENTION

It is therefore an object of the present invention to provide a texture mapping method that eliminates artifacts and improves the performance of graphics system in texture filtering without a large number of memory accesses according to the texture's coordinates and the pixel's shape on the texture map.

To achieve the above object, the present invention provides a texture mapping method for processing a plurality of pixels. According to the first embodiment of the invention, a texture mapping method includes the follows steps. First, a unique texture coordinate is calculated according to the texture coordinates of each pixel. Then, a texture filtering process is perform according to the unique texture coordinate, so as to obtain a color value of the texture filtering. Finally, the color value is assigned to each of the pixels.

According to the second embodiment of the invention, the texture mapping method includes the follows steps. First, the pixels are grouped into a plurality of pixel sets. For each pixel set, a unique texture coordinate is calculated according to the texture coordinates of each pixel in the pixel set. Then, a texture filtering process is perform according to the unique texture coordinate, so as to obtain a color value of the texture filtering. Finally, the color value is assigned to each of the pixels in the pixel set.

According to the embodiment, the texture filtering process is based on bilinear texture filtering.

According to the embodiment, the pixels are grouped according to the pixel's shape on the texture map.

### BRIEF DESCRIPTION OF THE DRAWINGS

The aforementioned objects, features and advantages of this invention will become apparent by referring to the following detailed description of the preferred embodiment with reference to the accompanying drawings, wherein:

FIG. 1 is a schematic diagram showing the structure of a texture processing system;

FIG. 2A is a schematic diagram illustrating the technique of nearest point sampling;

FIG. 2B is a schematic diagram illustrating the technique of bilinear texture filtering;

FIG. 2C is a schematic diagram illustrating the technique of trilinear texture filtering;

FIG. 3 is a schematic diagram illustrating the magnification of a texture;

FIG. 4 is a flow chart illustrating the operation of a texture mapping method according to the first embodiment of the present invention;

FIG. 5 is a flow chart illustrating the operation of a texture mapping method according to the second embodiment of the present invention;

FIG. 6 shows a grouping example according to the second embodiment of the present invention; and

FIG. 7 shows another grouping example according to the second embodiment of the present invention.

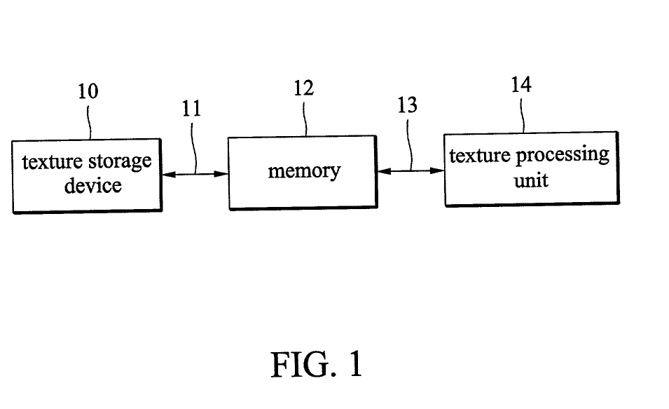

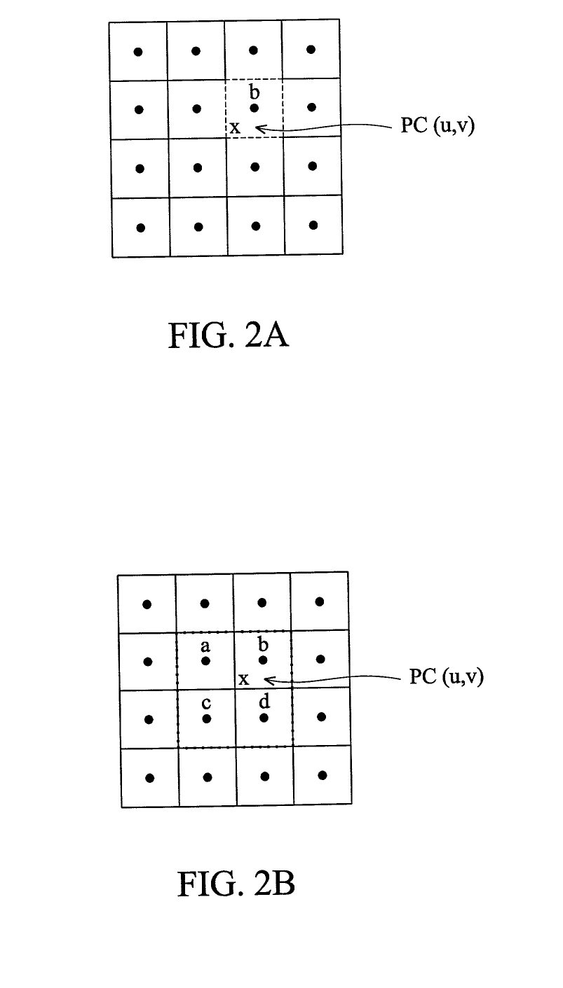

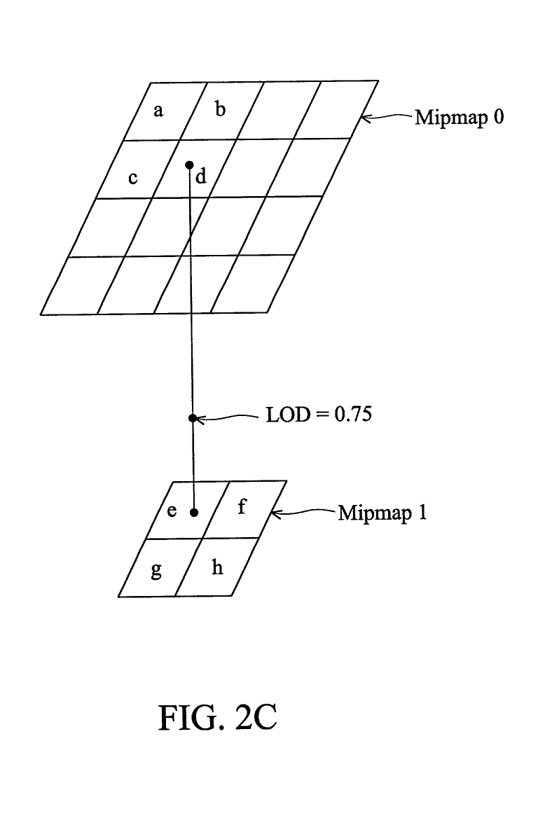

### DETAILED DESCRIPTION OF THE PREFERRED EMBODIMENT

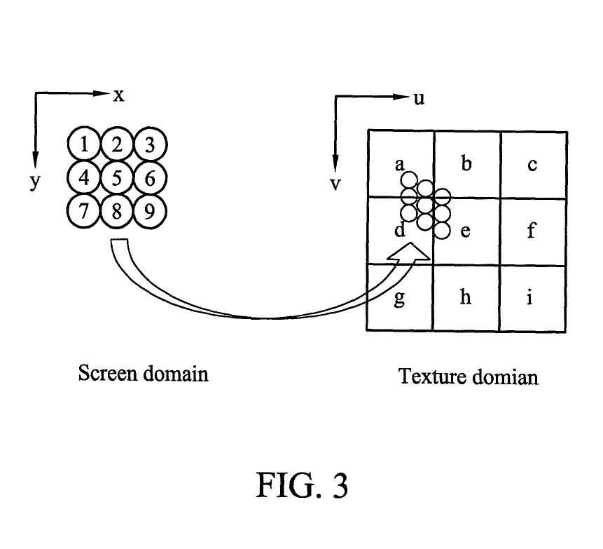

FIG. 3 illustrates the magnification of a texture. Magnification of a texture can result in many pixels being mapped to the same texel. The area represented by one pixel is smaller than the area of one texel in the texture map, as shown in FIG. 3. In this example, texels a, b, d and e are used to perform bilinear texture filtering for all of the pixels 1, 2, 3, 4, 5, 6, 7, 8 and 9.

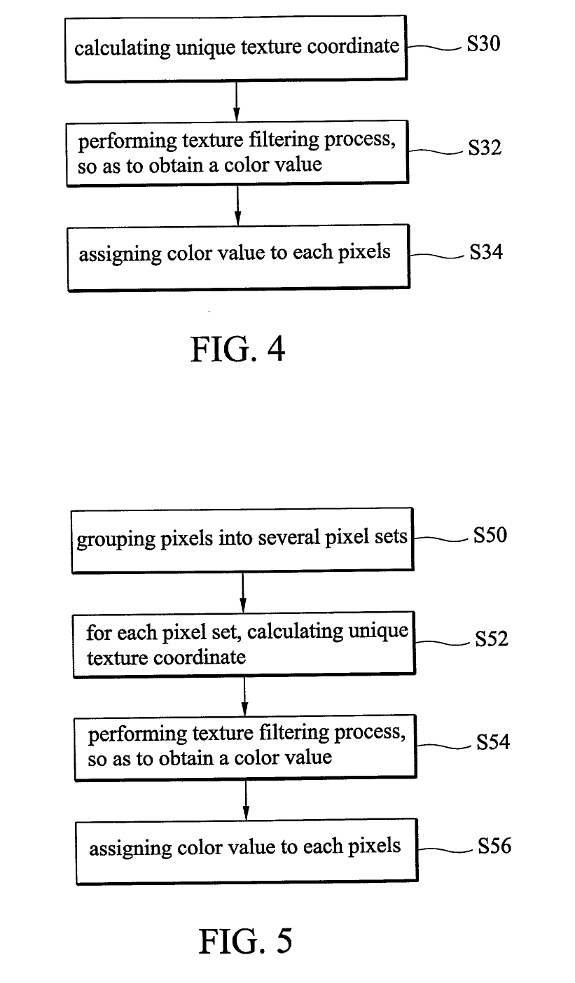

FIG. 4 illustrates the operation of a texture mapping method according to the first embodiment of the present invention. When the texture is magnified to map to the pixels, first, in step S30, a unique texture coordinate on the texture map is calculated according to the texture coordinates of pixel 1, 2, 3, 4, 5, 6, 7, 8 and 9. For example, the unique texture coordinate may be obtained by averaging the texture coordinates of pixel 1, 2, 3, 4, 5, 6, 7, 8 and 9.

Then, in step S32, a texture filtering process is perform according to the unique texture coordinate, so as to obtain a color value of the texture filtering. For example, the texture filtering process can be based on the technique of bilinear texture filtering. The color value is equal to:

a×w1+b×w2+d×w3+e×w4; where wn (w1, w2, w3 and w4) represents the weight of each texel corresponding to the unique texture coordinate.

Finally, in step S34, the color value of the texture filtering is assigned to pixel 1, 2, 3, 4, 5, 6, 7, 8 and 9.

In the first embodiment, mapping a single result of texture filtering to multiple pixels induces artifacts or jagged edges in the final image. Therefore, reducing the size of group of pixels can eliminate the artifacts. For example, two pixels may be grouped to reduce artifacts if high magnification ratio of pixel to texel occurs.

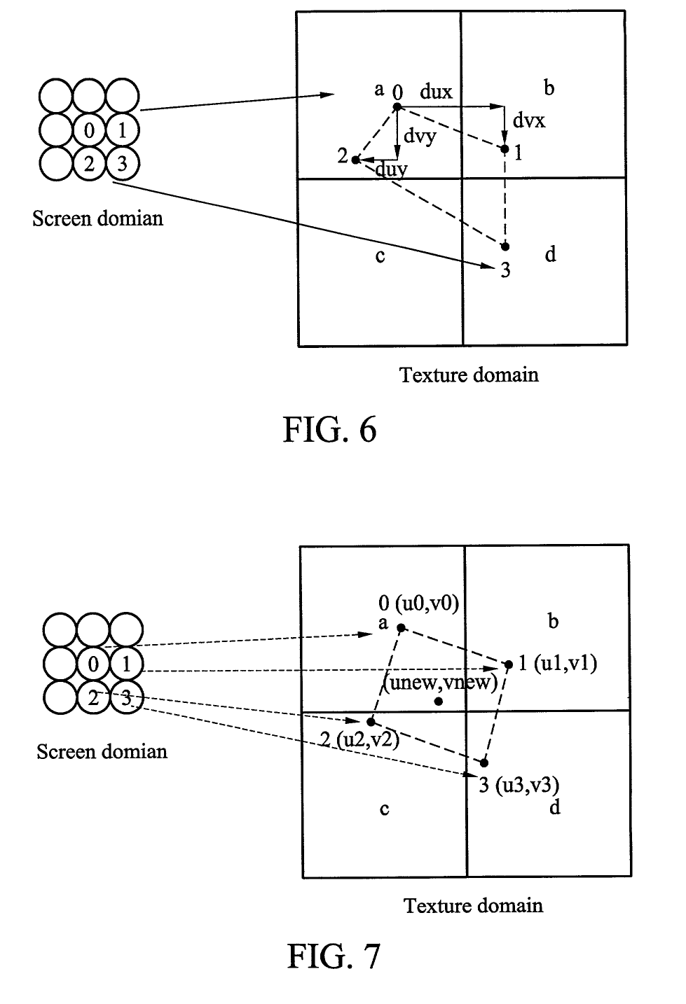

According to the texture's coordinates and the pixel's shape on the texture map, the result of texture filtering is assigned to a group of pixels when multiple pixels are mapped to the same texel. FIG. 5 illustrates the operation of a texture mapping method according to the second embodiment of the present invention. FIG. 6 shows a grouping example, pixels 0, 1, 2, and 3 on screen domain map to one texel on texture domain respectively.

First, in step S50, pixel 0, 1, 2 and 3 are grouped into a plurality of pixel sets. Note that, when pixels from a primitive are mapped into texels, their shape may be distorted. If the width is greater than height of the pixel's shape on the texture, the nearest vertical pixel pairs are grouped. Otherwise, the nearest horizontal pixel pairs are grouped. In other words, the pixels are grouped according to the pixel's shape on the texture map.

In the example of FIG. 6, the pixel shape on the texture is determined by calculate the dux, dvx, duy and dvy. If the difference of u coordinates is greater than difference of v coordinates, the vertical pixel pairs are grouped, otherwise, the horizontal pixel pairs are grouped. In this case, pixel 0 and 2 are grouped and pixel 1 and 3 are grouped.

Then, in step S52, a unique texture coordinate is calculated according to the texture coordinates of each pixel in the pixel set for each pixel set. Thereafter, in step S54, a texture filtering process is perform according to the unique texture coordinate, so as to obtain a color value of the texture filtering. Finally, in step S56, the color value is assigned to each of the pixels in the pixel set. Similarly, the texture filtering process can be based on the technique of bilinear texture filtering.

In the example of FIG. 6, texture coordinates of pixel 0 and pixel 2 are averaged and used for calculating a weighted average of the texels' values (a, b, c and d). The color value of bilinear texture filtering is assigned to pixel 0 and pixel 2. The same texture filtering process is applied to pixel 1 and pixel 3.

FIG. 7 shows another grouping example according to the second embodiment of the present invention. Four pixels (2 by 2) are grouped and use the unique texture coordinate (Unew,Vnew) for performing bilinear texture filtering process. The unique texture coordinates (Unew,Vnew) is generated by averaging four texture coordinates pairs ((u0,v0),(u1,v1),(u2,v2),(u3,v3)).

Also, the present invention can be applied to the trilinear filtering. In trilinear texture filtering, bilinear filtering is performed on the two nearest mipmaps, then interpolates linearly between the two values to determine a final pixel value according to the level of detail (LOD). The modified bilinear texture filtering of the present invention is performed on the two nearest mipmaps, then interpolates linearly between the two values to determine a final pixel value according to the value of LOD.

As a result, using the texture mapping method according to the present invention, the performance of computer graphics system will be dramatically improved and hardware cost reduced.

Although the present invention has been described in its preferred embodiment, it is not intended to limit the invention to the precise embodiment disclosed herein. Those who are skilled in this technology can still make various alterations and modifications without departing from the scope and spirit of this invention. Therefore, the scope of the present invention shall be defined and protected by the following claims and their equivalents.

What is claimed is:

1. A texture mapping method for processing a plurality of pixels with texture mapping, comprising the steps of:
calculating a unique texture coordinate according to the texture coordinates of each pixel;
performing a texture filtering process according to the unique texture coordinate, so as to obtain a color value of the texture filtering; and
assigning the color value to each of the pixels.

2. The method as claimed in claim 1 wherein the unique texture coordinate is obtain by averaging the texture coordinates of the pixels.

3. The method as claimed in claim 1 wherein the texture filtering process is based on bilinear texture filtering.

4. The method as claimed in claim 1 wherein the texture filtering process is based on trilinear texture filtering.

5. A texture mapping method for processing a plurality of pixels with texture mapping, comprising the steps of:
grouping the pixels into a plurality of pixel sets;
for each pixel set, calculating a unique texture coordinate according to the texture coordinates of each pixel in the pixel set;
performing a texture filtering process according to the unique texture coordinate, so as to obtain a color value of the texture filtering; and
assigning the color value to each of the pixels in the pixel set.

6. The method as claimed in claim 5 wherein the unique texture coordinate is obtain by averaging the texture coordinates of the pixels in the pixel set.

7. The method as claimed in claim 5 wherein the texture filtering process is based on bilinear texture filtering.

8. The method as claimed in claim 5 wherein the texture filtering process is based on trilinear texture filtering.

9. The method as claimed in claim 5 wherein the pixels are grouped according to the pixel's shape on the texture map.
